(19) United States
(12) Patent Application Publication
(10) Pub. No.: US 2006/0029229 A1
(43) Pub. Date: Feb. 9, 2006

(54) QKD station with EMI signature suppression

(76) Inventors: Alexei Trifonov, Boston, MA (US); Joseph E. Gortych, Colchester, VT (US)

Correspondence Address: MAGIQ TECHNOLOGIES, INC, 171 MADISON AVENUE, SUITE 1300, NEW YORK, NY, 10016-5110, US

(21) Appl. No.: 10/910,209

(22) Filed: Aug. 3, 2004

(51) Int. Cl. H04K 1/00

(52) U.S. Cl. 380/256

(57) ABSTRACT

Methods and systems for suppressing the electromagnetic interference (EMI) signature generated by a QKD station are disclosed. One of the methods includes generating two or more modulator drive signals corresponding to two or more of the n possible modulator states of the particular QKD protocol. The modulator drive signals are sent to a random number generation (RNG) unit, which randomly selects one of the two or more modulator drive signals and passes it to the modulator. Another method involves generating two modulator drive signals, wherein the voltage sum is constant. One signal is sent to the modulator while the other is sent to a circuit-terminating element, which can be a second modulator. The method suppresses the EMI signature associated with individual modulation states. This prevents an eavesdropper from gaining information about the modulator states via the EMI signature, which information could otherwise yield information about the exchanged key.

### FIELD OF THE INVENTION

The present invention relates to quantum cryptography, and in particular relates to method and systems for enhancing the security of a quantum key distribution (QKD) system by suppressing (e.g., reducing, eliminating or obscuring) electromagnetic emissions.

### BACKGROUND OF THE INVENTION

Quantum key distribution involves establishing a key between a sender QKD station (“Alice”) and a receiver QKD station (“Bob”) by using weak (e.g., 0.1 photon on average) optical signals transmitted over a “quantum channel.” The security of the key distribution is based on the quantum mechanical principle that any measurement of a quantum system in an unknown state will modify its state. As a consequence, an eavesdropper (“Eve”) that attempts to intercept or otherwise measure the quantum signal will introduce errors into the transmitted signals and thus reveal her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). The basics of quantum cryptography are described in the article by Gisin et al, entitled “Quantum Cryptography,” Reviews of Modern Physics, Vol. 74, January 2002 (pages 145 to 195), which article is incorporated by reference herein as background material.

Specific QKD systems are described in U.S. Pat. No. 5,307,410 (the '410 patent) to C. H. Bennett, in the publication by C. H. Bennett entitled “Quantum Cryptography Using Any Two Non-Orthogonal States”, Phys. Rev. Lett. 68 3121 (1992), and in the book by Bouwmeester et al., entitled “The Physics of Quantum Information,” Springer-Verlag 2001, in Section 2.3, pages 27-33. All of the above-cited references are incorporated herein by reference as background information.

In a typical QKD system, Alice randomly encodes the polarization or phase of single photons, and Bob randomly measures the polarization or phase of the photons. The one-way system described in the Bennett 1992 paper and in the '410 patent is based on a shared interferometric system. Respective parts of the interferometric system are accessible by Alice and Bob so that each can control the phase of the interferometer.

During the QKD process, Alice uses a true random number generator (TRNG) to generate a random bit for the basis (“basis bit”) and a random bit for the key (“key bit”) to create a qubit (e.g., using polarization or phase encoding). She then sends this qubit to Bob, who randomly measures (modulates) the qubit. This process can loosely be referred to as “qubit encoding” at Alice and “qubit decoding” at Bob.

In the typical QKD system, either polarization or phase modulators are used at each QKD station to respectively encode and decode the qubits. Such modulators are randomly driven by a modulator driver that sends the modulator a modulator drive signal. The modulator drive signals have different strengths (e.g., voltages, such as V[0], V[π], V[π/2] and V[3π/2]) corresponding the different modulation states (e.g., phase states of 0, π, π/2 and 3π/2) called for by the particular QKD protocol.

The random activation of the modulators using different modulator drive signal strengths can, under certain circumstances, pose a security risk to an otherwise secure QKD system. With reference to FIG. 1, there is shown a schematic diagram of prior art version of a QKD station Alice for a one-way QKD system. Alice includes a light source 12 that emits coherent light pulses P0. Alice also includes a (polarization or phase) modulator MA downstream of light source 12 and optically coupled thereto via, e.g., an optical fiber section 16. Modulator MA is coupled to a modulator driver 20, which in turn is couple to a true random number generator (RNG) 30. Alice also includes a controller 40 coupled to light source 12 and to RNG 30. Alice further typically includes a housing H that encloses all of the above-described elements.

In operation, controller 40 sends a control signal S0 to light source 12 to initiate the emission of initial light pulse P0. Controller 40 also sends an activation signal S1 to RNG 30 that causes the RNG to generate a random number. The random number is embodied in a control signal S2 sent from RNG 30 to modulator driver 20. Modulator driver 20 receives control signal S2 and in response thereto generates a corresponding modulator drive signal (e.g., a voltage) S3 and sends it to modulator MA. The modulator drive signal sets modulator MA to a corresponding modulator state for a time interval corresponding to the duration of modulator drive signal S3.

The activation of modulator MA is timed (gated) to coincide with the arrival of initial light pulse P0 by the synchronized operation of the controller. The result is a randomly modulated light pulse P1 that leaves Alice and travels to Bob, e.g., via an optical fiber link FL connecting Alice to Bob (not shown).

FIG. 2 is a close up schematic diagram of FIG. 1 of modulator driver 20 as it generates modulator drive signal S3. The modulator drive signals S3 vary in strength to correspond to one of the n possible modulator states. Also shown in FIG. 2 is housing H, along with a first radiation detector (antenna) A1 external to housing H, and a second antenna A2 internal to housing H. Antennas A1 and A2 are tuned to received electromagnetic radiation and are assumed to have been surreptitiously placed in their respective locations by an eavesdropper (“Eve,” not shown) who is seeking to gain information about the state of modulator MA during the operation of the QKD system.

When modulator driver 20 generates different drive signals S3 (typically in the range of 0 to 5 volts or so for a phase modulator), it also emits corresponding electromagnetic radiation R3 (dashed lines). This radiation, which differs in relation to the different modulator drive signals S3, can be picked up directly by Eve's internal antenna A2, or through housing H by external antenna A1. This radiation is sometimes referred to as electromagnetic interference (EMI). The detected radiation (i.e., EMI “signature”) can then be used by Eve to gain information about the state of modulator MA, and ultimately information about the keys exchanged between Alice and Bob. This eavesdropping technique, which is relatively easy to implement as compared to other eavesdropping techniques (such as a Trojan horse attack or man-in-the-middle attack) can result in a catastrophic security breach of an otherwise perfectly secure QKD system.

### BRIEF DESCRIPTION OF THE DRAWINGS

FIG. 1 is a schematic diagram of a prior art QKD station Alice for a one-way system illustrating the operation of the modulator in encoding qubits;

FIG. 2 is a close-up of the QKD station Alice of FIG. 1, showing the modulator driver and modulator, along with the radiation (R3) associated with the modulator driver;

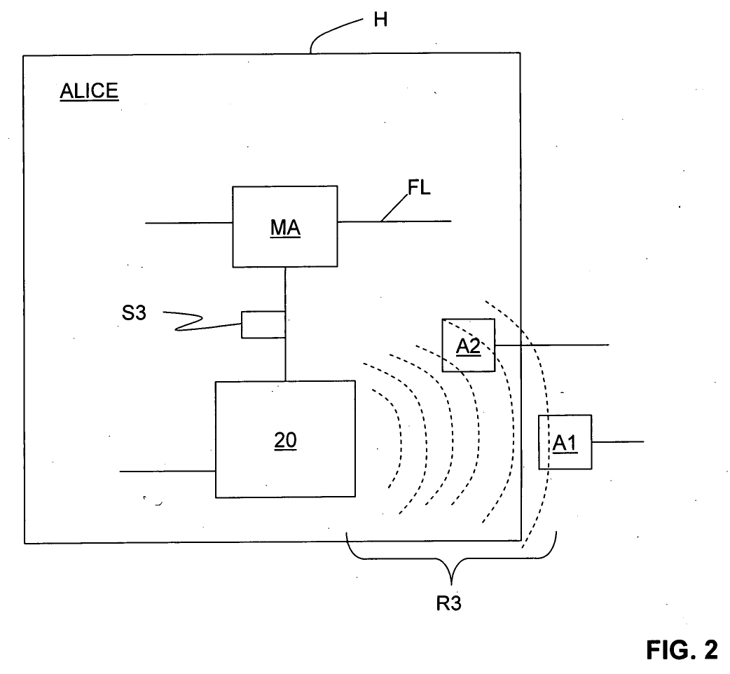

FIG. 3 is a schematic diagram of an example embodiment of a QKD station Alice similar to that of FIG. 1, but modified to eliminate or suppress the EMI signature from the modulator driver; and

FIG. 4 is a schematic diagram of an example embodiment of a QKD station Alice similar to that of FIG. 3, but that further includes an additional RNG that allows for the modulator driver to send a random subset of the entire set of possible modulator drive signals to the RNG unit, which then randomly selects and passes one of the sent modulator drive signals;

FIG. 5 is a schematic diagram of another example embodiment of a QKD station Alice similar to that of FIG. 1, wherein the controller is adapted to generate two modulator drive signals, wherein the first modulator drive signal (S3R) is provided to the “real” modulator (MA) and the second modulator drive signal S3F is a “fake” signal provided to circuit-terminating element (MF); and

FIG. 6 is a detailed schematic diagram of the modulator driver of FIG. 5.

The various elements depicted in the drawings are merely representational and are not necessarily drawn to scale. Certain sections thereof may be exaggerated, while others may be minimized. The drawings are intended to illustrate various embodiments of the invention that can be understood and appropriately carried out by those of ordinary skill in the art.

### SUMMARY OF THE INVENTION

A first aspect of the invention is a method of modulating light in a QKD system. The QKD system is presumed to have a modulator capable of being set to two or more modulator states according to a particular QKD protocol. The method includes simultaneously (or nearly simultaneously) generating two or more modulator drive signals corresponding to the two or more modulator states. The method also includes randomly passing one of the two or more modulator drive signals to the modulator to suppress the EMI signatures associated with each individual modulator setting.

A second aspect of the invention is a method of modulating light in a QKD system having first modulator optically coupled to a laser source and capable of being set to two or more modulator states. The method includes generating first and second modulator drive signals having respective first and second voltages, wherein the sum of the first and second voltages is a constant. The method further includes passing the first modulator drive signal to the first modulator.

A third aspect of the invention is a QKD station that operates under a QKD modulation protocol. The QKD station includes a modulator arranged to modulate light pulses passing therethrough. The modulator may be, for example, a polarization modulator or a phase modulator. The QKD station also includes a modulator driver adapted to simultaneously (or nearly simultaneously) generate two or more modulator drive signals. The QKD station further includes a random number generation (RNG) unit connected to the modulator and the modulator driver. The RNG unit is adapted to receive and randomly select one of the two or more modulator drive signals and pass the selected modulator drive signal to the modulator.

A fourth aspect of the invention is a QKD station that operates under a QKD modulation protocol. The QKD station includes a first modulator arranged to modulate light pulses passing therethrough. A modulator driver is coupled to the first modulator and to a circuit-terminating element. The modulator driver is adapted to generate first and second modulator drive signals based on a random control signal provided thereto. The first and second modulator drive signals have respective first and second voltages, the sum of which is a constant. The first modulator drive signal is provided to the first modulator, and the second modulator drive signal is provided to the circuit-terminating element.

### DETAILED DESCRIPTION OF THE INVENTION

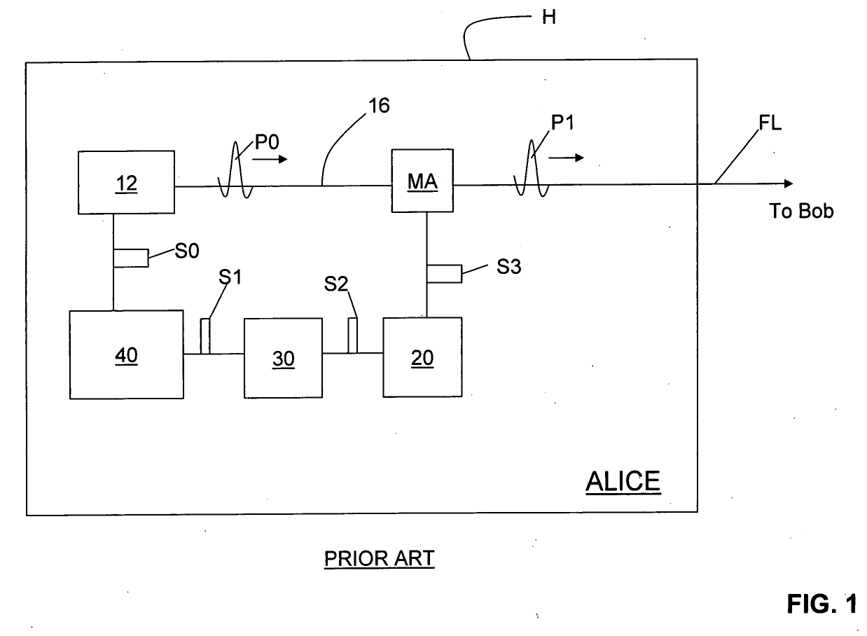

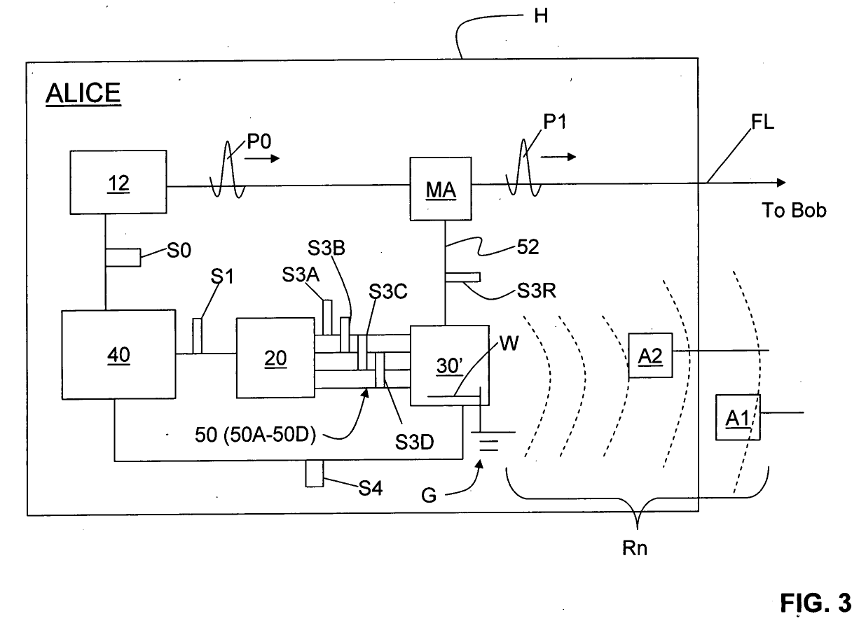

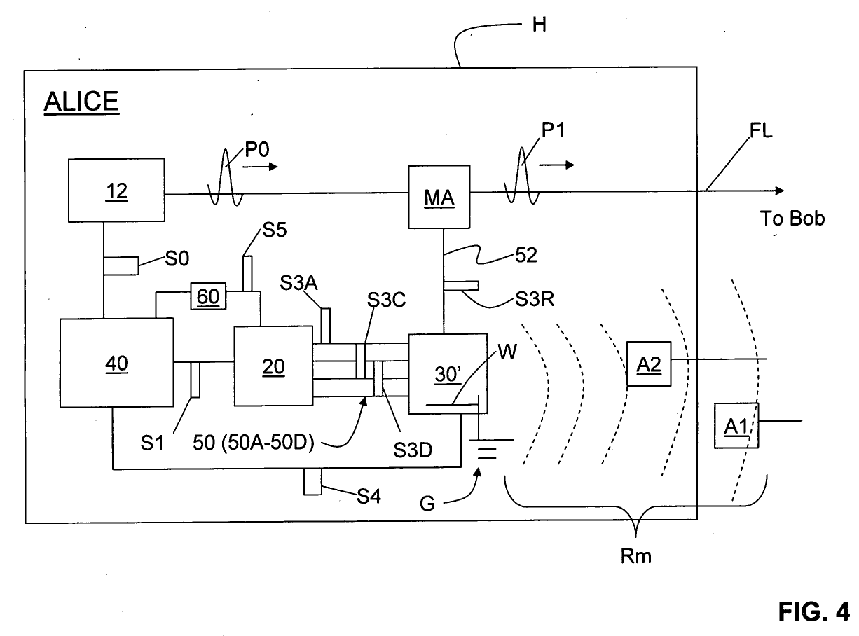

FIG. 3 is a schematic diagram of an example embodiment of a QKD station Alice similar to the Alice of FIG. 1, but modified to suppress (e.g., eliminate, reduce or otherwise obscure) the EMI signature associated with the different modulator driver voltages. Alice of FIG. 3 includes many of the same elements as Alice of FIG. 1, and these elements have the same reference number in FIG. 3. Further, only the main differences between the Alice of FIG. 1 and the Alice of FIGS. 3 and 4 are described below.

n Modulator Drive Signal Embodiment

In the example embodiment of Alice of FIG. 3, modulator driver 20 is operatively connected to controller 40, and an RNG unit 30′ is operably connected to the modulator driver via connection 50. RNG unit 30′ is also operably connected to modulator MA via connection 52. RNG unit 30′ is adapted to generate random numbers, and for each random number pass a corresponding one of the received modulator drive signals S3. Further, modulator driver 20 is adapted to simultaneously or nearly simultaneously provide two or more of the plurality n of modulator drive signals S3 (e.g., S3A, S3B, . . . S3n) to RNG unit 30′.

In an example embodiment, all n of the modulator drive signals S3 are generated simultaneously by modulator driver 20. In another example embodiment, the modulator drive signals S3 are generated by the modulator driver close enough in time to implement the invention, i.e., to suppress the EMI signature associated with the modulation process, wherein the unsuppressed EMI could otherwise reveal information about the modulation state. For the purposes of the description herein, these two embodiments relating to the timing of the generated modulator drive signals are respectively described by the phrases “simultaneously” and “nearly simultaneously.”

In an example embodiment, multiple drive signals S3 (S3A, S3B, . . . S3n) are carried from modulator driver 20 to RNG unit 30′ via an embodiment of connection 50 that has n independent connections (i.e., 50A, 50B, . . . 50n), where n is the number of possible modulation states. In an example embodiment, the independent connections are wires linking the modulator driver and the RNG unit. Four connections 50 (50A-50D) are shown for the sake of illustration, corresponding to a QKD protocol requiring four possible modulator states (e.g., phase states of 0, π/2, π, 3π/2).

In an example embodiment, connections 50 and 52 are adapted to allow each drive signal S3 to propagate the same distance, regardless of whether RNG unit 30′ passes the signal to modulator MA. In an example embodiment, this is accomplished by providing suitable wiring W that allows the modulator drive signals not passed to the modulator to propagate for the same amount of time as the modulator drive signal sent to the modulator. For example, wiring W is made to have the same length as the connection length for connections 50 and 52 so that each of the signals S3 starts and stops at the same time. This ensures that there is no lingering radiation from one of the signals that could be detected by Eve through antenna 1 and/or antenna 2. In an example embodiment, wiring W is formed and terminated (e.g., connected to ground G) directly within (or partially within) RNG unit 30′, as shown.

With continuing reference to FIG. 3, in response to activation signal S1 from controller 40, in an example embodiment modulator driver 20 generates all n of the modulator drive signals S3 (S3A, S3B, . . . S3n) of the particular QKD protocol. Each modulator drive signal is delivered to RNG unit 30′ via connection 50. RNG unit 30′ then randomly selects one of the signals to be passed to modulator MA. This signal is identified in FIG. 3 as SR. The process of passing signal SR to modulator MA is repeated for each light pulse P0.

In an example embodiment, RNG unit 30′ acts in response to receiving the drive signals. In another example embodiment, RNG unit 30′ is connected to controller 40 and acts in response to a timed control signal S4 provided by the controller.

Associated with modulator driver 20 generating all n of the drive signals S3 is corresponding radiation Rn. In an example embodiment, radiation Rn is emitted once for every light pulse P0 to be modulated, and is the same each time modulator driver 20 is activated. Accordingly, an eavesdropper having access to information received by antenna A1 and/or antenna A2 will not receive any information about the actual modulation state of modulator MA. Thus, the radiation emitted by the modulator driver no longer provides information about the modulator state because all of the modulator drive signals are generated while only one is (randomly) passed to the modulator.

Further, even if antennae A1 and A2 were sensitive enough to detect radiation generated by RNG unit 30′, such radiation would not contain any significant information about the modulator state, particularly in the case where the propagation lengths for drive signals S3 are the same.

m<n Modulator Drive Signal Embodiment

In the example embodiment of the present invention described above, the entire plurality (n) of modulator drive signals S3 is sent to RNG unit 30′ to suppress, eliminate or otherwise obscure the EMI signature associated with the individual modulator drive signals. However, in another example embodiment, a random subset m (where 1<m<n) of the modulator drive signals S3 is sent to the RNG unit, which then randomly passes one signal from the subset.

With reference to FIG. 4, this is accomplished, for example, by coupling a RNG unit 60 to modulator driver 20 and controller 40. An RNG signal S5 corresponding to a random number is then provided to modulator driver 20 by the RNG unit 60. In response thereto, modulator driver 20 provides a random subset m of the plurality n of possible modulator driver signals S3 to RNG unit 30′.

By way of example and as shown in FIG. 4, in one instance (i.e., for one of the pulses P0), only signals S3A, S3C and S3D (i.e., m=3) of the total (n=4) possible modulator drive signals are sent to RNG unit 30′. In this manner, the EMI signature (radiation) Rm so generated and detected by antennae A1 and/or A2 is scrambled. This precludes Eve from obtaining any useful information about the actual modulator state.

Two Modulator Drive Signal Embodiment

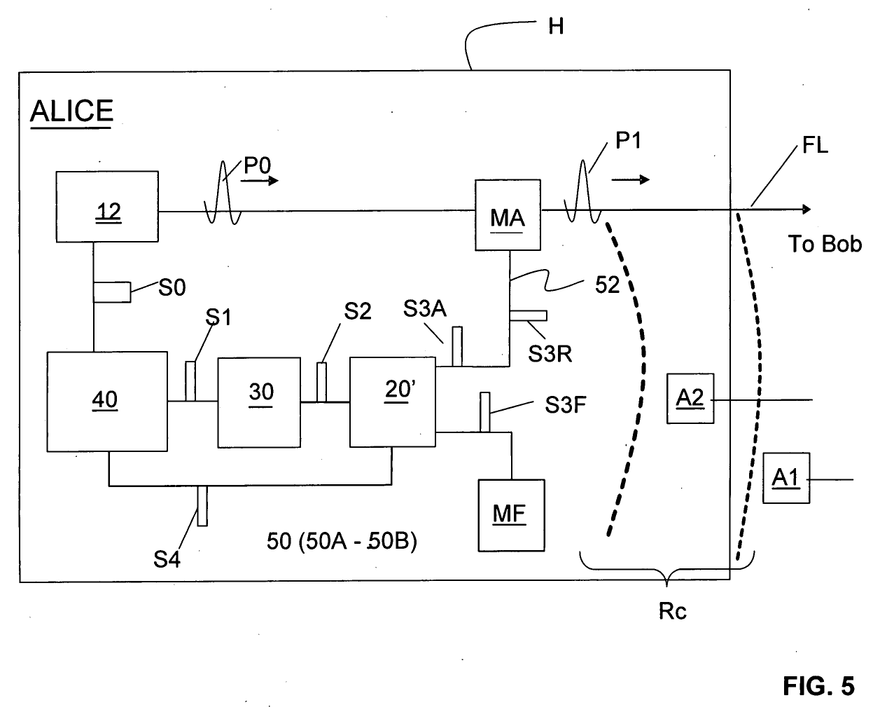

FIG. 5 is a schematic diagram of a QKD station Alice similar to that of FIG. 1. Alice of FIG. 5 has a modified modulator driver 20′, and includes a circuit-terminating element MF coupled to modulator driver 20′. In an example embodiment, circuit-terminating element MF is a modulator similar or identical to modulator MA. In other example embodiments, circuit-terminating element is a resistor (e.g., a 50 Ohm resister) or ground. Alice of FIG. 5 also includes controller 40 coupled to RNG unit 30, as in the Alice of FIG. 3.

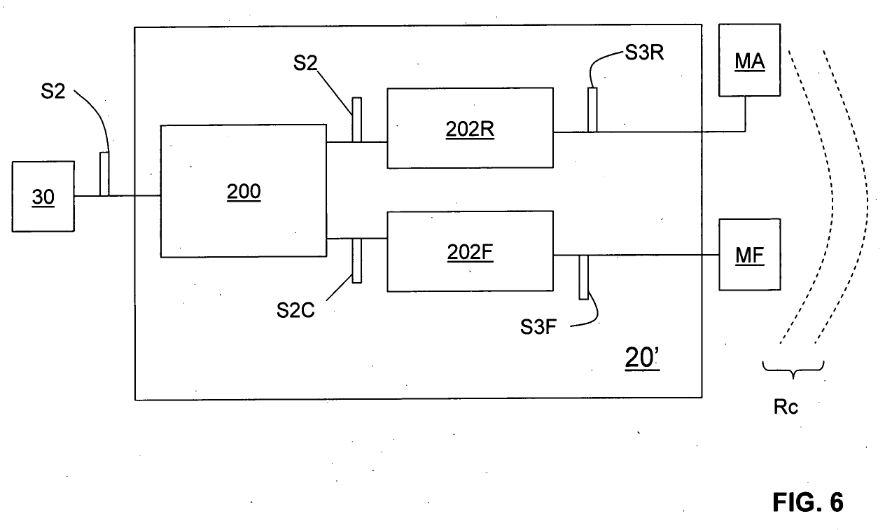

FIG. 6 is a detailed schematic diagram of modulator driver 20′. Modulator driver 20′ includes controller 200 coupled to two modulator drivers 202R and 202F. The output of modulator driver 202R is a “real” signal SR that travels to and drives modulator MA, while the output of modulator driver 202F is a “fake” signal SF that travels to circuit-terminating element MF.

In operation, control signal S2 from RNG 30 is received by controller 200 of modulator driver 20′. Controller 200 includes logic that identifies the voltage level of control signal S2 and then passes the control signal to modulator driver 202R. Controller 200 also is adapted to generate another voltage signal S2C (e.g., a complementary voltage signal as compared to signal S2) that is sent to modulator driver 202F.

Modulator driver 202R, in response to receiving signal S2C from controller 200, generates a modulator drive signal S3R that sets modulator MA to a given phase. Likewise, modulator driver 202F, in response to receiving signal S2F from controller 200, generates a complimentary modulator drive signal S3F. In the example where circuit-terminating element is a modulator, modulator drive signal S3F sets this modulator to a setting complementary to that of modulator MA.

Thus, in an example embodiment, if modulator drive signal S3R has a voltage V_{R} and the “fake” modulator drive signal S3F has a voltage V_{F}, then V_{R}+V_{F}=constant. For example, the constant voltage might be a voltage V_{3π/2} corresponding to the voltage for setting a modulator at a phase of 3π/2.

Accordingly, an eavesdropper attempting to gain information about the settings of modulator MA via antennae A1 and/or A2 will only be able to detect a constant radiation R_{C} corresponding to an apparent constant modulator voltage.

In the foregoing Detailed Description, various features are grouped together in various example embodiments for ease of understanding. For example, the above-description was described in connection with four possible modulator states for the sake of illustration, though the invention applies generally o two or more modulator states. Thus, the many features and advantages of the present invention are apparent from the detailed specification, and, thus, it is intended by the appended claims to cover all such features and advantages of the described apparatus that follow the true spirit and scope of the invention. Furthermore, since numerous modifications and changes will readily occur to those of skill in the art, it is not desired to limit the invention to the exact construction, operation and example embodiments described herein. Accordingly, other embodiments are within the scope of the appended claims.

What is claimed is:

1. A method of modulating light in a QKD system having a modulator capable of being set to two or more modulator states, comprising:
simultaneously or nearly simultaneously generating two or more modulator drive signals corresponding to the two or more modulator states; and
randomly passing one of the two or more modulator drive signals to the modulator.

2. The method according to claim 1, wherein the two or more modulator states generated represents all of the modulator states of a QKD protocol.

3. The method according to claim 1, wherein the two or more modulator states represents a subset of all of the modulator states of a QKD protocol, and wherein the subset includes more than one but less than all of the modulator states.

4. The method of claim 1, wherein the two or more modulator drive signals propagate the same distance.

5. A method of modulating light pulses in a QKD system having a modulator capable of being set to a plurality n of modulator states in accordance with a QKD protocol, the method comprising for each light pulse:
for each light pulse, generating the plurality n of modulator drive signals close enough in time to suppress or eliminate radiation signatures associated with each modulator drive signal; and
randomly passing one of the plurality of modulator drive signals to the modulator.

6. The method of claim 5, including providing the n modulator drive signals to a random number generation (RNG) unit adapted to receive the n modulator drive signals and randomly select one of the n modulator drive signals to pass to the modulator.

7. A method of modulating light pulses in a QKD system having a modulator capable of being set to a plurality (n) of modulator states in accordance to a QKD protocol, comprising for each light pulse:
randomly generating m modulator drive signals, where 1<m<n; and
randomly passing one of the m modulator drive signals to the modulator.

8. The method of claim 7, including providing the m modulator drive signals to a random number generation (RNG) unit adapted to receive the m modulator drive signals and randomly select one of the m modulator drive signals to pass to the modulator.

9. A method of modulating light in a QKD system having first modulator optically coupled to a laser source and capable of being set to two or more modulator states, comprising:
generating first and second modulator drive signals having respective first and second voltages, wherein the sum of the first and second voltages is a constant; and
passing the first modulator drive signal to the first modulator.

10. The method of claim 9, including not using the second modulator drive signal to modulate light.

11. The method of claim 9, including sending the second modulator drive signal to a second modulator that does not modulate light.

12. The method of claim 9, including:
forming the first and second modulator drive signals using first and second modulator drivers based on a control signal generated by a random number generator.

13. A method of suppressing a first electromagnetic interference (EMI) signature, comprising:
generating a first signal to activate an active element, wherein generating said first signal creates the first EMI signature; and
generating a second signal that does not activate the active element, and wherein generating said second signal creates a second EMI signature that obscures the first EMI signature.

14. The method of claim 13, including generating the first and second signals to have associated therewith first and second voltages that add up to a constant voltage regardless of the first signal voltage.

15. A QKD station that operates under a QKD modulation protocol, comprising:
a modulator arranged to modulate light pulses passing therethrough;
a modulator driver adapted to simultaneously or near simultaneously generate two or more modulator drive signals; and
a random number generation (RNG) unit operatively connected to the modulator and to the modulator driver and adapted to receive and randomly select one of the two or more modulator drive signals and pass said one randomly selected modulator drive signal to the modulator.

16. The QKD station according to claim 15, wherein the QKD modulation protocol calls for n different modulator states, and wherein the modulator driver simultaneously or nearly simultaneously generates all n of the modulator drive signals.

17. The QKD station according to claim 15, wherein the QKD modulation protocol calls for n different modulator states, and wherein:
the QKD station further includes an RNG operatively coupled to the modulator driver, wherein the RNG is adapted to provide signals to the modulator driver representative of random numbers, and wherein in response thereto, the modulator driver simultaneously or nearly simultaneously generates m of the n modulator drive signals, wherein 1<m<n.

18. A QKD station that operates under a QKD modulation protocol, comprising:
a first modulator arranged to modulate light pulses passing therethrough;
a modulator driver coupled to the first modulator and to a circuit-terminating element, the modulator driver adapted to generate first and second modulator drive signals based on a random control signal provided thereto, the first and second modulator drive signals having respective first and second voltages, the sum of which is a constant; and
wherein the first modulator drive signal is provided to the first modulator and the second modulator drive signal is provided to the circuit-terminating element.

19. The QKD station of claim 18, wherein the circuit-terminating element is a second modulator.
